(19) United States
(12) Patent Application Publication
(10) Pub. No.: US 2018/0135785 A1
(43) Pub. Date: May 17, 2018

(54) AXIAL METAL SEAL RETAINER FOR IMPROVED FATIGUE RESISTANCE

(71) Applicant: Parker-Hannifin Corporation, Cleveland, OH (US)

(72) Inventor: Jason Richard Koller, Chaska, MN (US)

(21) Appl. No.: 15/566,928

(22) PCT Filed: Apr. 29, 2016
(86) PCT No.: PCT/US2016/029964

§ 371 Date: Oct. 16, 2017

Related U.S. Application Data
(60) Provisional application No. 62/156,397, filed on May 4, 2015.

(51) Int. Cl. F16L 17/035; F16L 37/40; F16L 37/56

(52) U.S. Cl. CPC F16L 17/035; F16L 37/56; F16L 37/40

(57) ABSTRACT

A seal retainer (60) having an axially facing surface with an axially facing concave portion (64) for receiving a convex face of a sealing member (66). The axially facing concave portion (64) allows the sealing member (66) to be seated in the axially facing concave portion (64) and retain at least some of its shape when under pressure, such as separation pressure within a quick coupling, to reduce stresses acting on the sealing member (66). Thus, the sealing member (66) may undergo less fatigue when cycling between a pressurized and non-pressurized state. Reducing fatigue allows sealing members, such as metal sealing members, to endure a greater amount of cycles before leaking, which reduces replacement costs of the sealing members.

### RELATED APPLICATIONS

This application claims the benefit of U.S. Provisional Application No. 62/156,397 filed May 4, 2015, which is hereby incorporated herein by reference.

### TECHNICAL FIELD

The present disclosure relates generally to fluid seals, and more particularly to reducing fatigue of fluid seals for hydraulic couplings.

### BACKGROUND

Quick couplings are devices that allow connection of a single fluid line without a need for special tools. Individual quick couplings typically have a ball locking mechanism to prevent male and female portions of the quick couplings from separating due to internal hydraulic pressure during use.

Multi-couplings typically utilize a group of quick couplings that have male and female portions mounted together in a corresponding plate or casting. Instead of an individual locking mechanism, such as a ball locking mechanism, a larger centralized locking mechanism may connect and lock the male portions in one plate to the corresponding female portions in the other plate. Increased pressures within the quick couplings increase separation loads and can require additional loads to connect the quick couplings.

Increasing separation loads increases the amount of force required to connect and lock the quick couplings, and may require a more effective sealing mechanism between corresponding male and female portions of the quick couplings. Sealing mechanisms commonly utilize elastomeric or polymeric seals, but elastomeric and polymeric materials have limitations regarding pressure, temperature, and chemical compatibility. Metal seals are often used to avoid the disadvantages associated with elastomeric and polymeric materials.

### SUMMARY

The present disclosure provides a seal retainer having an axially facing surface with an axially facing concave portion for receiving a convex face of a sealing member. The axially facing concave portion allows the sealing member to be seated in the axially facing concave portion and retain at least some of its shape when under pressure, such as separation pressure within a quick coupling, to reduce stresses acting on the sealing member. Thus, the sealing member may undergo less fatigue when cycling between a pressurized and non-pressurized state. Reducing fatigue allows sealing members, such as metal sealing members, to endure a greater amount of cycles before leaking, which reduces replacement costs of the sealing members.

The axially facing concave portion may generally extend circularly about a longitudinal axis and have a cross-sectional profile that is configured to support the sealing member. For example, the sealing member may be a metal C-shape ring seal that has an open end facing axially and an axially facing convex face. A cross-section of the axially facing concave portion, parallel to the longitudinal axis, may be C-shape to receive the axially facing convex face. Alternatively, the cross-section parallel to the longitudinal axis may be another suitable shape, such as a V-shape or a trapezoidal shape.

According to one aspect of the disclosure, a seal retainer of a hydraulic component, the seal retainer includes a radially inward facing surface extending about a longitudinal axis and extending along the longitudinal axis, an axially facing surface extending radially outward from the radially inward facing surface, the axially facing surface facing in a first direction along the longitudinal axis, and an axially facing concave portion formed in the axially facing surface, the axially facing concave portion facing in the first direction and configured to receive a convex face of a sealing member, wherein the axially facing concave portion extends along a curved axis, the curved axis being coaxial with the longitudinal axis and circumscribing the longitudinal axis.

According to another aspect of the disclosure, a hydraulic coupling includes a female hydraulic coupling component that includes a housing having an opening configured to receive a male hydraulic coupling component, and having a flow cavity fluidly connectable to the opening and extending along a longitudinal axis, the male hydraulic coupling component being engaged with the female hydraulic coupling component, and a seal retainer in the opening, the seal retainer that includes a radially inward facing surface extending about the longitudinal axis and extending along the longitudinal axis, wherein the radially inward facing surface is configured to receive a radially outwardly facing surface of the male hydraulic coupling component, an axially facing surface extending radially outward from the radially inward facing surface, the axially facing surface facing in a first direction along the longitudinal axis, and an axially facing concave portion formed in the axially facing surface, the axially facing concave portion facing in the first direction and configured to receive a convex face of a sealing member, wherein the axially facing concave portion extends along a curved axis, the curved axis being coaxial with the longitudinal axis and circumscribing the longitudinal axis.

The foregoing and other features of the invention are hereinafter described in greater detail with reference to the accompanying drawings.

### BRIEF DESCRIPTION OF THE DRAWINGS

FIG. 1 is a perspective view of a multi-coupling holding a plurality of exemplary male coupling components and female coupling components.

FIG. 2 is a perspective view of a male and female coupling component of FIG. 1.

FIG. 3 is a front view of the female coupling component of FIG. 2.

FIG. 4 is a side view of a partial cross-section of the female coupling component of FIG. 2 including an exemplary seal retainer.

FIG. 5 is an enlarged side view of a portion of the partial cross-section of the female coupling component including the seal retainer of FIG. 4.

FIG. 6 is a side view of a partial cross-section of the female coupling component of FIG. 4 and the male coupling component of FIG. 2 engaged with the female coupling component.

FIG. 7 is a partial perspective view of an exemplary sealing member of FIG. 6.

FIG. 8 is an enlarged side view of female coupling component engaged with the male coupling component of FIG. 6.

FIG. 9 is a front view of the seal retainer of FIG. 4.

FIG. 10 is a side view of a cross-section of the seal retainer of FIG. 9.

FIG. 11 is a side view of a partial cross-section of a valve assembly with another exemplary seal retainer.

FIG. 12 is a side view of a partial cross-section of the valve assembly of FIG. 11 with accompanying arrows showing pressure on the sealing member.

FIG. 13 is a side view of a cross-section of another exemplary seal retainer.

FIG. 14 is a side view of a cross-section of yet another exemplary seal retainer.

### DETAILED DESCRIPTION

The principles of this present application have particular application to female coupling components for hydraulic systems and thus will be described below chiefly in this context. For example, the female coupling components may connect hydraulic control lines. It will be appreciated that principles of this disclosure may be applicable to other hydraulic systems where it is desirable to prevent leakage of hydraulic fluid.

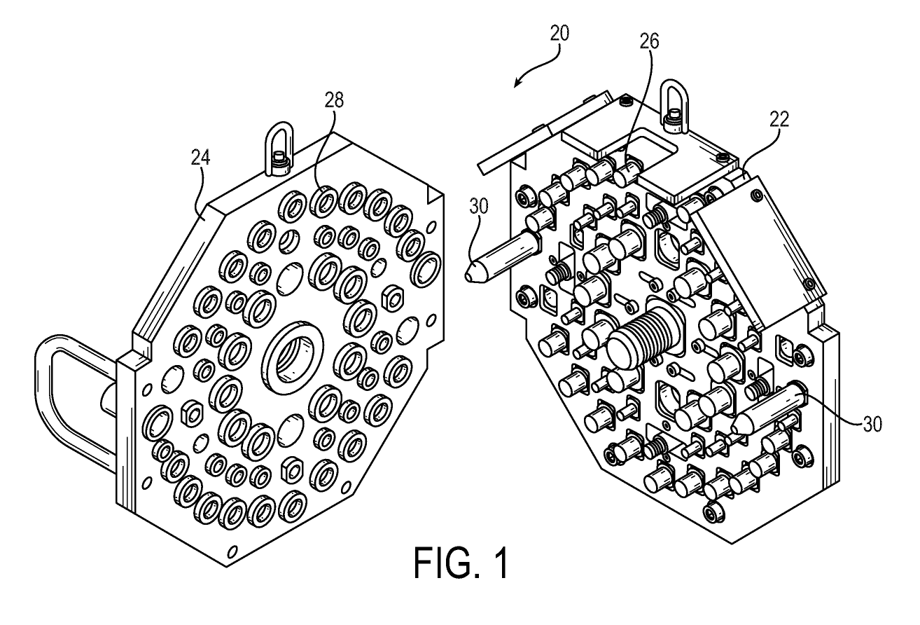

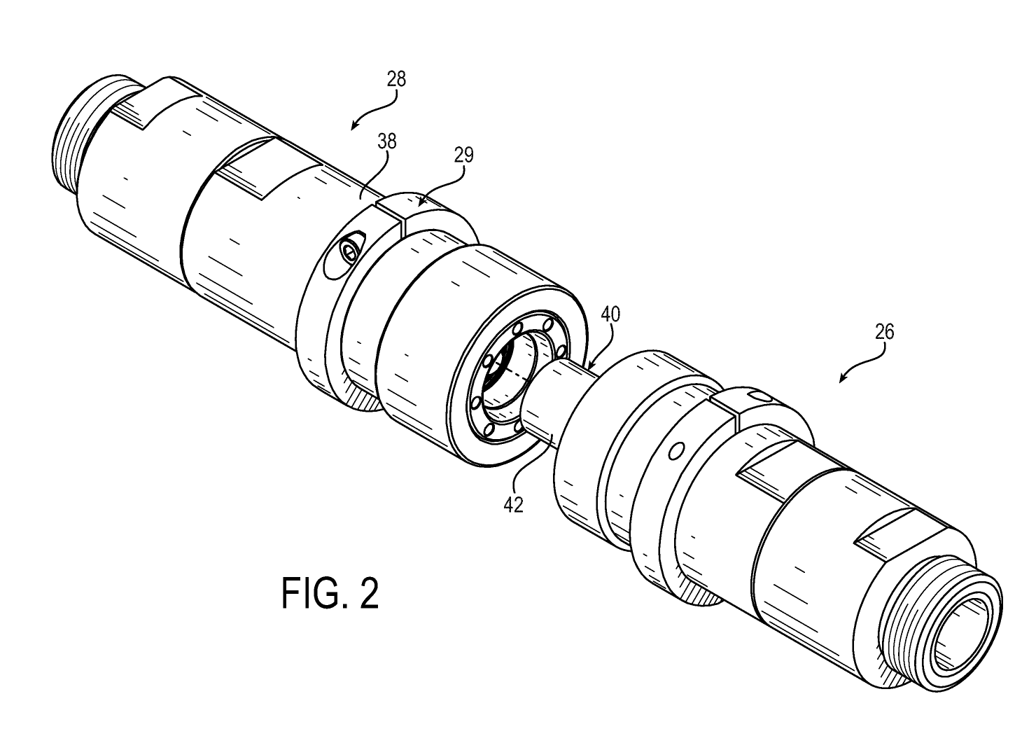

Referring now to the drawings and initially to FIG. 1, a multi-coupling is designated generally by reference numeral 20. The multi-coupling 20 can be provided, for example, as part of a hydraulic system (not shown) for sub-sea hydraulic applications, such as providing hydraulic fluid to sub-sea oil wells. The multi-coupling 20 may include a fixed plate 22 and a free plate 24 for securing a plurality of male coupling components 26 and a plurality of female coupling components 28, respectively. In an embodiment, the female coupling components include a clam shell retainer 29 (shown in FIG. 2) to secure the female coupling components to the free plate. An example can be found in U.S. application Ser. No. 14/665,250 filed Mar. 23, 2015 and titled MULTI-COUPLING WITH SERVICEABLE LOCKING MECHANISM, which is hereby incorporated by reference in its entirety. The fixed plate 22 may include a guide pin 30 at each side of the fixed plate 22 for guiding the free plate 24 against the fixed plate 22 to align the female coupling components 28 to engage with the male coupling components 26. After engagement, the fixed plate 22 and the free plate 24 may lock together to prevent disengagement of the male coupling components 26 and the female coupling components 28.

Hydraulic lines (not shown) may fluidly connect to each of the male coupling components 26 and the female coupling components 28 to provide hydraulic fluid, for example to provide hydraulic power to a corresponding oil well (not shown).

FIG. 2 is a perspective view of one male coupling component 26 and one corresponding female coupling component 28 having a coupler body 38. The male coupling component 26 includes a nipple 40 having a radially outward facing surface 42 for engaging with an interior portion within the coupler body 38 of the female coupling component 28. When engaged, the radially outward facing surface 42 may seal against a radially inward facing surface of the female coupling component 28.

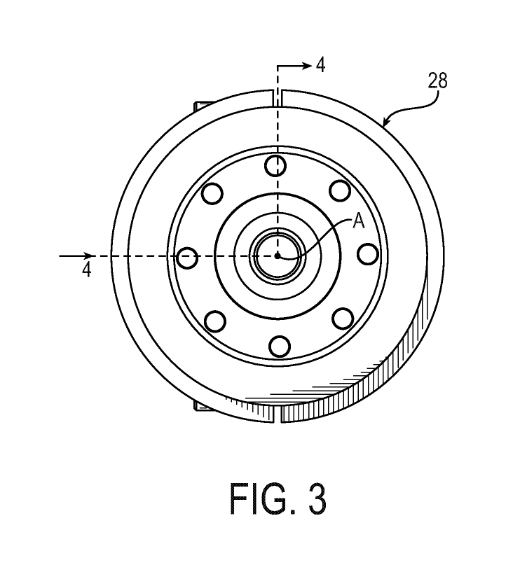

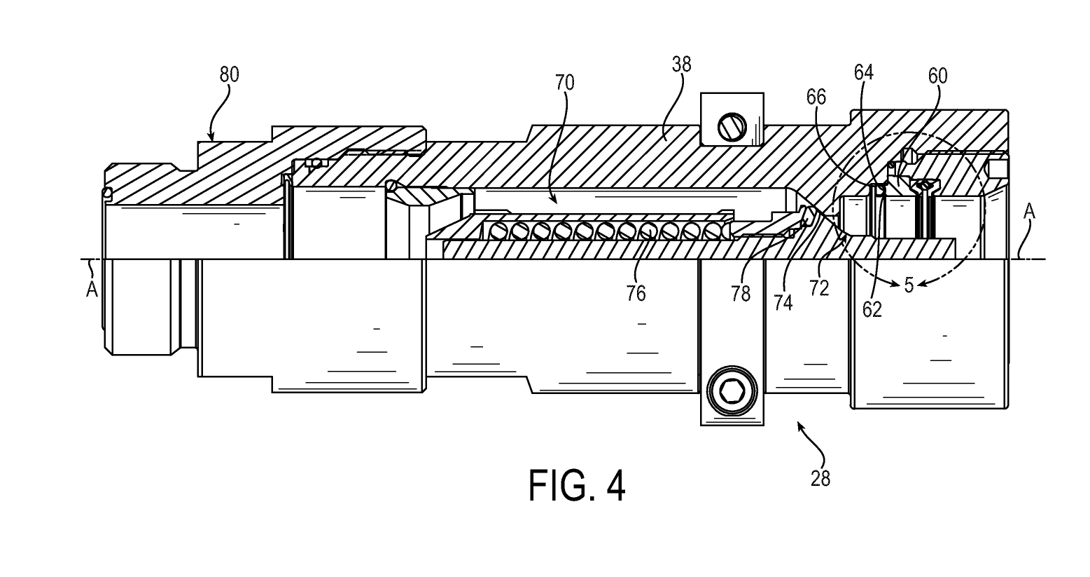

FIGS. 3 and 4 illustrate the female coupling component 28 extending along a longitudinal axis A. FIG. 4 provides a side view of a partial cross-section of a seal retainer 60 held within the coupler body 38. The seal retainer 60 may include an axially facing retainer surface 62 with an axially facing concave portion 64 for securing a sealing member. Securing the sealing member prevents leakage of hydraulic fluid between the coupler body 38 and the male coupling component 26 (FIG. 2), when the female coupling component 28 and the male coupling component 26 are engaged.

The sealing member may include a C-ring seal 66 with an axially facing opening opposite the seal retainer 60 to allow the C-ring seal 66 to seal radially inwardly and/or radially outwardly, relative to the longitudinal axis A. For example, a radially outward portion of the C-ring seal 66 may engage with a male coupling component 26 (FIG. 2) to seal against the male coupling component 26 (FIG. 2).

The coupler body 38 may include a flow cavity 70 for allowing fluid flow, along the longitudinal axis A, through the female coupling component 28. The female coupling component 28 may include a valve 72 and a valve seat 74 for engaging with the valve 72 to selectively restrict fluid flow through the flow cavity 70. For example, flow through the flow cavity 70 may be restricted when the female coupling component 28 and the male coupling component 26 are disengaged. Also, flow through the flow cavity 70 may be allowed when the female coupling component 28 and the male couple component 26 are engaged.

The female coupling component 28 may further include a resilient member 76 and a valve seal 78. The resilient member 76 may induce the valve 72 and the valve seal 78 into a closed position against the valve seat 74. The valve seal 78 may be a ring seal for providing additional sealing engagement to prevent leakage of fluid between the valve 72 and the valve seat 74.

The female coupling component 28 may also include an adapter 80 at an axial end opposite the seal retainer 60. The adapter 80 may allow the female coupling component 28 to fluidly connect to a separate hydraulic line (not shown) or another hydraulic component (not shown) to allow fluid to flow through the flow cavity 70 and out the adapter 80 to the hydraulic line or the hydraulic component. For example, fluid may flow through a central opening in the adapter 80 to a central opening in the coupler body 38 where the fluid may flow radially outwardly about the valve 72 and follow a generally longitudinal path until reaching the valve seat 74. When the valve 72 is open the fluid may continue to follow a longitudinal path out of the coupler body 38. Alternatively, the fluid may flow in an opposite direction from the hydraulic line or the hydraulic component through the adapter and further through the flow cavity.

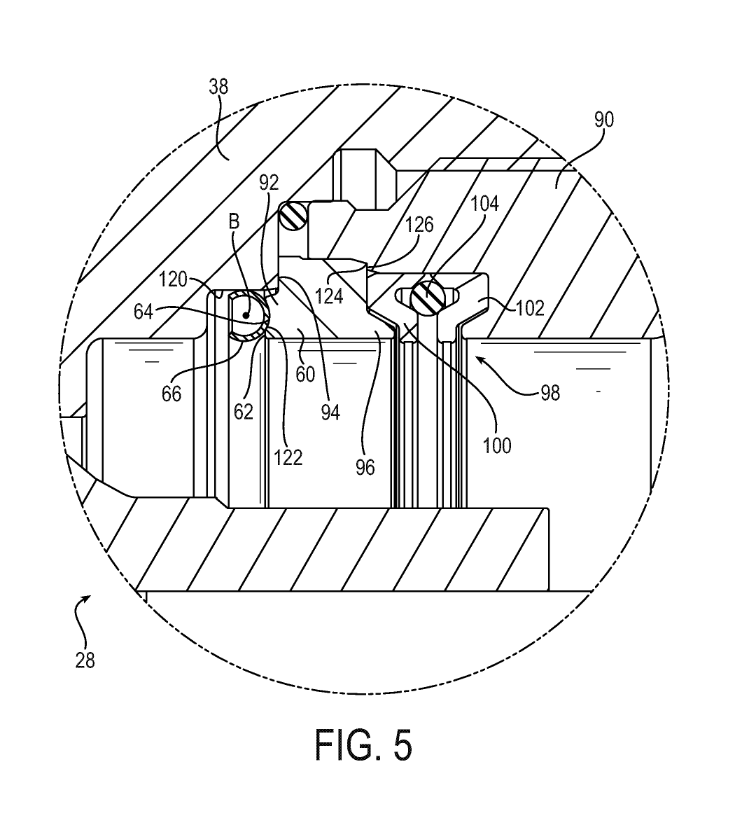

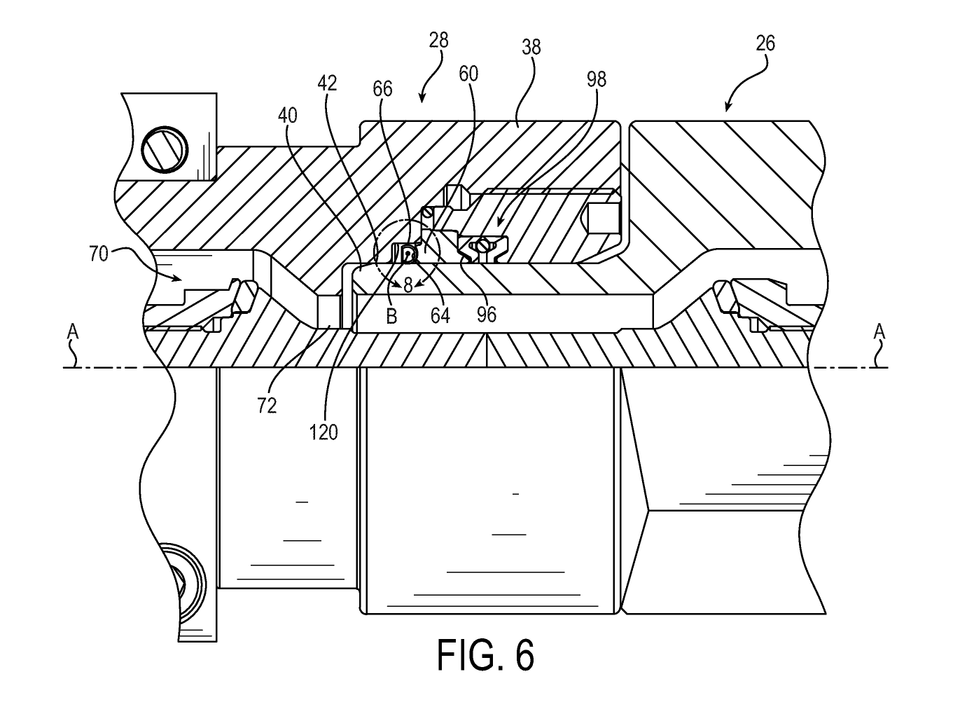

Referring now to FIGS. 5 and 6, the axially facing retainer surface 62 and the axially facing concave portion 64 of the seal retainer 60 are illustrated in further detail with the C-ring seal 66. The seal retainer 60 may be axially retained against the coupler body 38 by a secondary retainer 90 that is fixed to the coupler body 38. For example, threading on a radially outwardly facing surface of the secondary retainer may engage radially inwardly facing threads of the coupler body to secure the secondary retainer 90 to the coupler body 38, and thereby retain the seal retainer 60. Alternatively, the secondary retainer may be fixed to the coupler body in any other suitable manner, such as press-fitting the secondary retainer into the coupler body.

The seal retainer 60 may be fixed at an end of the coupler body 38 that receives the male coupling component 26 (FIG. 6). The position of the seal retainer 60 may allow the C-ring seal 66 to prevent axial movement of the C-ring seal 66 in a direction toward the seal retainer 60 when the C-ring seal 66 is seated in the axially facing concave portion 64. The seal retainer 60 may include an axially extending ledge 92 extending longitudinally beyond a portion of an axially facing body surface 94 that engages the seal retainer 60. At an opposite end, along the longitudinal axis A, the seal retainer 60 may include a foot 96 for securing a secondary seal 98 between the seal retainer 60 and the secondary retainer 90.

The C-ring seal 66 may be seated in the axially facing concave portion 64 to seal against a radially inward facing surface 120 of the coupler body 38. The C-ring seal 66 may have a radially inwardly facing surface facing toward the longitudinal axis A for sealing against the radially outward facing surface 42 of the nipple 40 of the male coupling component 26 (FIG. 6).

Referring briefly to FIG. 6 alone, the male coupling component 26 is engaged with the female coupling component 28 to open the valve 72, thereby allowing fluid to flow through the flow cavity 70. When the fluid flows, pressure in the fluid may force some of the fluid between the radially outward facing surface 42 and the coupler body 38. The fluid may reach the C-ring seal 66, which may cause the C-ring seal 66 to expand radially outwardly, relative to a curved axis, such as circular axis B, to seal against the radially inward facing surface 120 of the coupler body 38 and the radially outward facing surface 42 of the nipple 40. The circular axis B may circumscribe the longitudinal axis A—coaxial with the longitudinal axis A—in a plane perpendicular to the longitudinal axis A.

Referring again to FIGS. 5 and 6, an axially facing surface 122, relative to the longitudinal axis, of the C-ring seal 66 may extend along the circular axis B. The axially facing surface 122 may face in a direction opposite the axially facing concave portion 64 to allow the axially facing surface 122 and the axially facing concave portion 64 to engage one another. The axially facing surface 122 may partially circumscribe the circular axis B in a C-shape. The axially facing surface 122 may circumscribe the circular axis B with a radius less than a corresponding radius of the axially facing concave portion 64 to allow the axially facing surface 122 to expand radially outward from the circular axis B after abutting a portion of the axially facing concave portion 64.

The secondary seal 98 may include a pair of V-shape ring seals 100, 102 for sealing against the radially outwardly facing surface 42 of the nipple 40 (FIG. 6) of the male coupling component 26 (FIG. 6). The V-shape ring seals 100, 102 may sandwich a ring member 104, which may be a spring or sealing member for supporting the V-shape ring seals 100, 102 and/or providing additional sealing against the radially outwardly facing surface 42 of the nipple 40 (FIG. 6) as a backup seal for the C-ring seal 66.

The secondary retainer 90 may be a ring shape, coaxial with the longitudinal axis A, with an axially facing surface 124 for engaging an opposing axially facing surface 126 of the seal retainer 60. The axially facing surface 124 of the secondary retainer 90 may, along the longitudinal axis A, axially fix a radially outward portion of the axially facing retainer surface 62 of the seal retainer 60 to the opposing axially facing body surface 94 of the coupler body 38.

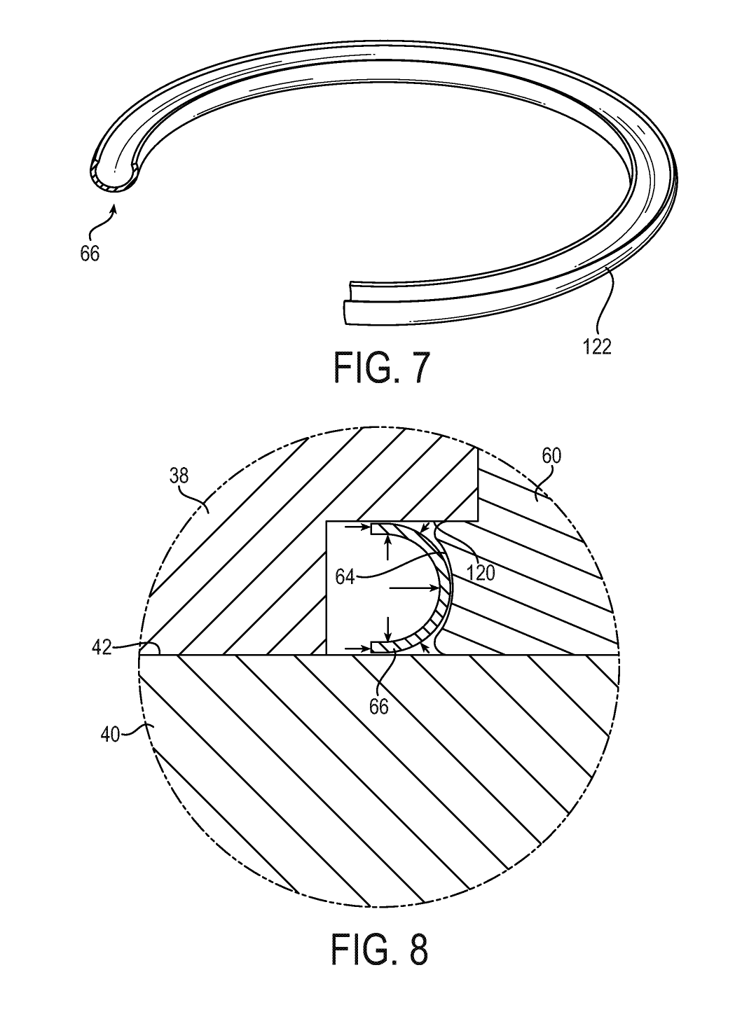

Referring briefly to FIG. 7, the C-ring seal 66 is shown with a perspective view with a section removed for illustrative purposes. The entire C-ring seal 66 extends circumferentially 360° to form a complete ring. For example, the C-ring seal 66 may form a complete circle about the longitudinal axis.

Referring briefly to FIG. 8, the C-ring seal 66 is illustrated as seated in the axially facing concave portion 64 of the seal retainer 60. Fluid may flow from a hydraulic system (not shown) to the C-ring seal 66. The fluid may flow between the radially outward facing surface 42 of the nipple 40, and the coupler body 38 to reach the C-ring seal 66 to pressurize the C-ring seal 66 causing the C-ring seal 66 to expand. Pressure forces acting on the C-ring seal 66 are illustrated with arrows. For example, a high fluid pressure may force a portion of the C-ring seal 66 against the radially outward facing surface 42. Also, fluid pressure may force another portion of the C-ring seal 66 against the radially inward facing surface 120. A low fluid pressure may come from between the seal retainer 60 and either the coupler body 38 or the radially outward facing surface 42, but the low fluid pressure may be significantly lower than the fluid pressure that causes the C-ring seal 66 to expand.

The high fluid pressure may be intermittent, thus causing respective ends of the C-ring seal 66 to expand and deform upon receiving the pressure and to constrict and deform when the high fluid pressure lowered or removed. The axially facing concave portion 64 supports the C-ring seal 66 to reduce deformation of the C-ring seal 66 when expanding and/or when contracting due to the intermittent pressures. Thus, fatigue loading of the C-ring seal 66 may be reduced. Further details of the axially facing concave portion 64 are provided below.

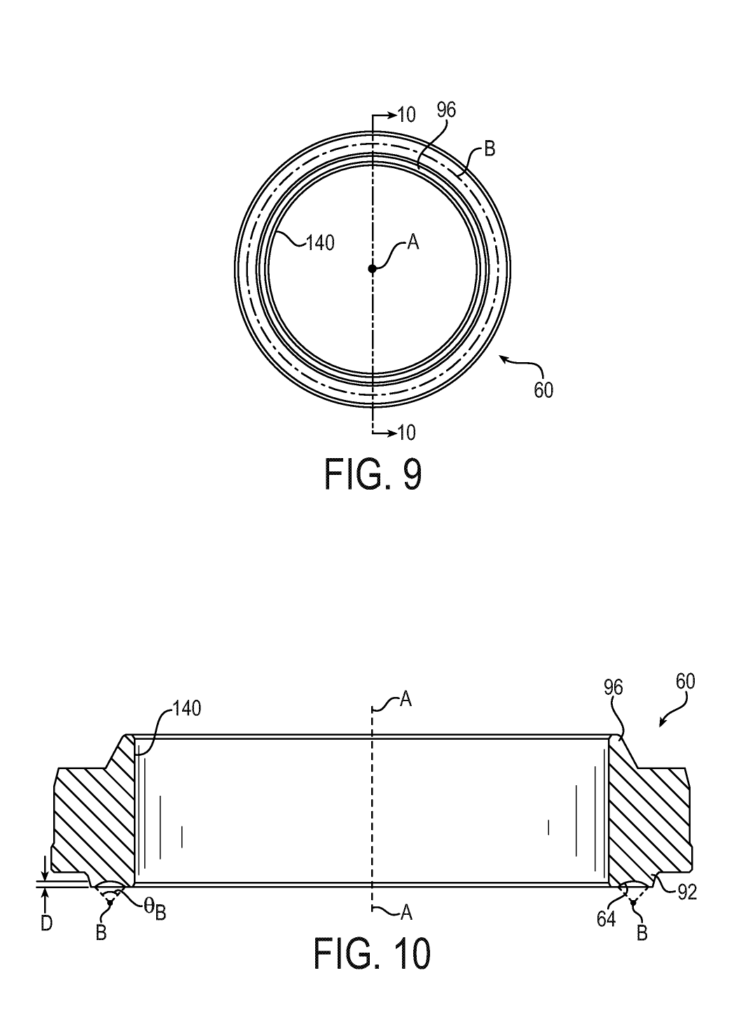

Referring now to FIGS. 9 and 10, the seal retainer 60 may be cylindrical with a radially inwardly facing surface 140—that is coaxial with the longitudinal axis A for receiving the male coupler component 28 (FIG. 6).

The foot 96 may be any suitable shape for retaining the secondary seal 98 (FIG. 8 only). The foot 96 is illustrated extending axially along the longitudinal axis A away from the ledge 92 and with a radially inwardly facing surface continuous with the radially inwardly facing surface 140. The foot 96 may be radially thinner at an end furthest from the axially extending ledge 92 compared to an end closest to the axially extending ledge 92 for accommodating the secondary seal 98 and for preventing radially inward movement of the secondary seal 98. In an embodiment, the seal retainer does not include a foot.

The axially extending ledge 92, as mentioned above, may axially off-set the C-ring seal 66. The axially extending ledge 92 may be coaxial with the circular axis B and include the axially facing concave portion 64. The axially facing concave portion 64 may have a larger radius compared to the radially inwardly facing surface 140, to radially outwardly off-set the C-ring seal 66 (FIG. 6). The distance of the radially outward off-set may be based on a size of the C-ring seal 66 and the axially facing concave portion 64. In an embodiment, the axially facing concave portion is off-set, relative to the longitudinally axis A, radially outward from the radially inwardly facing surface a distance less than a radius of the axially facing concave portion, relative to the circular axis B. In an alternative embodiment, the axially facing concave portion is not radially off-set from the radially inwardly facing surface.

The axially facing concave portion 64 may form a continuous concavity about the longitudinal axis A. The continuous concavity allows the corresponding sealing member to seat evenly in the axially facing concave portion 64. For example, the C-ring seal 66 may extend entirely along the circular axis B to be coaxial with the longitudinal axis A.

The radius of the axially facing concave portion 64 relative to the circular axis B may be based on the size of the C-ring seal 66 (FIG. 6). For example, the radius of the axially facing concave portion 64 may be between about 3% and about 10% larger than the radius of the C-ring seal 66 relative to the circular axis B to allow the C-ring seal 66 to expand radially outward relative to the circular axis B. Alternatively, the radius of the axially facing concave portion may be between about 4% and about 8% larger than the radius of the C-ring seal relative to the circular axis.

For example, the radius of the axially facing concave portion may be 8% larger than the radius of the C-ring seal (e.g., the radius of the axially facing concave portion may be 0.035″ to accommodate a C-ring seal with a radius of 0.0323″). In another example, the radius of the axially facing concave portion may be 4% larger than the radius of the C-ring seal (e.g., the radius of the axially facing concave portion may be 0.05″ to accommodate a C-ring seal with a radius of 0.048″). In an embodiment, relative to the circular axis, the radius of the axially facing concave portion is 5% larger than the radius of the sealing member.

An angle θ_{B} formed by the axially facing concave portion relative to the circular axis B may be based on the size and strength of the C-ring seal 66. For example, the angle θ_{B} may be anywhere from 60° to 120°. In an embodiment, the angle θ_{B} is anywhere from 60° to 90°.

A depth D of the axially facing concave portion, along the longitudinal axis A, may be based on the size and strength of the C-ring seal 66. For example, the depth D may be between 10% and 25% of the radius of the axially facing concave portion 64 relative to the circular axis B. For example, the depth may be anywhere from 0.007″ to 0.015″.

When a fluid pressurizes the C-ring seal 66 (FIG. 6) the radially outer and radially inner portions may expand radially, relative to the longitudinal axis A. Also, the seal retainer 60 may partially limit the expansion to reduce stress of the seal member 66. For example, the seal member 66 may expand within the seal retainer 60 and the seal retainer 60 may reinforce a curvature of the C-ring seal 66. The reinforcement may reduce deformation of the C-ring seal 66 due to the limiting of the expansion. The reinforcement may also prevent flattening of the C-ring seal 66 to improve sealing effectiveness of the C-ring seal 66.

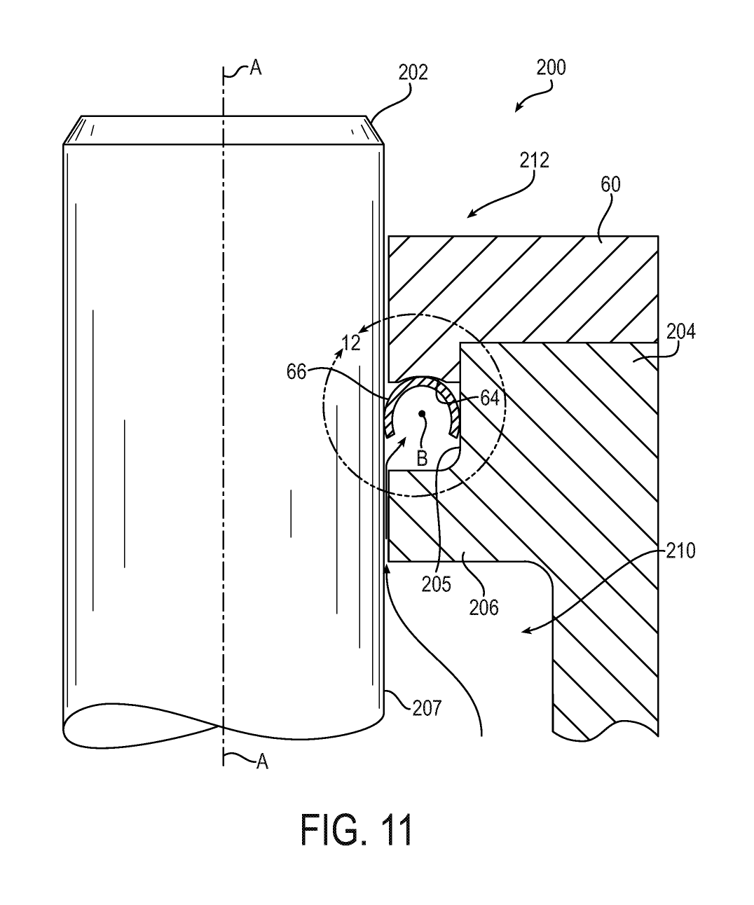

Turning now to FIG. 11, a valve assembly is shown at 200. The valve assembly 200 includes an exemplary embodiment of the seal retainer 60. The seal retainer 60 is substantially the same as the above-referenced seal retainer 60, and consequently the same reference numerals denote structures corresponding to similar structures in the seal retainers. In addition, the foregoing description of the seal retainer 60 is equally applicable to the following seal retainer 60 except as noted below. Moreover, it will be appreciated that aspects of the seal retainers may be substituted for one another or used in conjunction with one another where applicable.

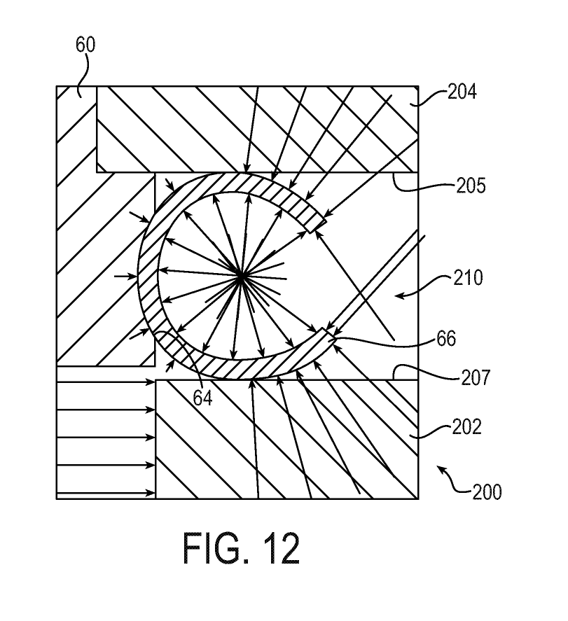

The valve assembly 200 may include a valve 202 that is moveable along a longitudinal axis A relative to an axially inner body 204 and the seal retainer 60. The seal retainer 60 has an axially facing concave portion 64 that may axially engage a C-ring seal 66 that circumscribes the valve 202. Engaging the C-ring seal 66 with the seal retainer 60 may prevent the C-ring seal 66 from moving axially with the valve 202 when the valve 202 extends in a first direction, e.g., parallel to the longitudinal axis A. Engaging the C-ring seal 66 with the seal retainer 60 also may prevent the C-ring seal 66 from moving in the first direction when fluid pressurizes the C-ring seal 66. The fluid pressure is represented by the illustrated arrows leading to the C-ring seal 66. The axially inner body 204 may include a radially inward ledge 206 (shown in FIG. 12) that may prevent movement of C-ring seal 66 in the second direction, opposite the first direction, away from the seal retainer 60. For example, the radially inward ledge 206 may prevent the C-ring seal 66 from moving with the valve 202 when the valve 202 retracts.

As illustrated in FIG. 12, pressurized fluid from an inner portion 210 of the valve assembly 200 and moving in the first direction may cause the C-ring seal 66 to expand within the axially facing concave portion 64. The expansion causes sides of the C-ring seal 66 to seal against a radially inwardly facing surface 205 of the axially inner body 204 and a radially outwardly facing surface 207 of the valve 202 to prevent fluid axial fluid flow between the respective components. Some fluid from outside of the valve assembly 200 may move in the second direction, opposite the first direction, to urge the C-ring seal 66 to contract and unseal the valve 202.

The fluid from the inner portion 210 of the valve assembly may act on an open end of the C-ring seal 66. The fluid from the inner portion 210 may have a higher pressure than the fluid from outside 212 of the valve assembly 200. The higher pressure in the fluid from the inner portion 210 causes the C-ring seal 66 to expand against the radially inwardly facing surface 205 and the radially outwardly facing surface 207. When expanded, the C-ring seal 66 may form a seal with the radially inwardly facing surface 205 and/or the radially outwardly facing surface 207.

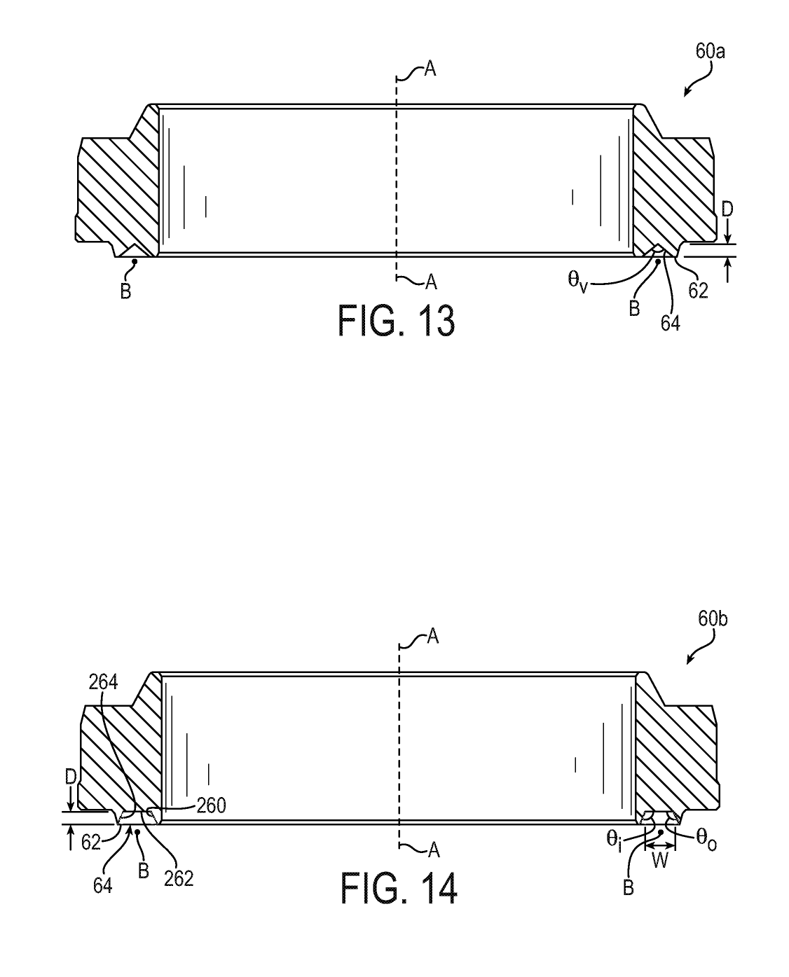

Turning now to FIG. 13, a seal retainer is shown at 60a. The seal retainer 60a is substantially the same as the above-referenced seal retainer 60, and consequently the same reference numerals denote structures corresponding to similar structures in the seal retainers. In addition, the foregoing description of the seal retainer 60 is equally applicable to the following seal retainer 60a except as noted below. Moreover, it will be appreciated that aspects of the seal retainers may be substituted for one another or used in conjunction with one another where applicable.

The seal retainer 60a may include an axially facing retainer surface 62 with an axially facing concave portion 64. The axially facing concave portion 64 may have a V-shape cross-section for receiving a closed end of a sealing member, for example a C-shape sealing member opening axially as shown in FIGS. 4-8, 11, and 12.

An angle θv formed by the axially facing concave portion 64, facing a circular axis B, may be based on the size and strength of the sealing member (e.g., as shown in FIG. 4 at numeral 66). For example, the angle θv may be anywhere from 80° to 120°. In an embodiment, the angle θv is anywhere from 90° to 110°.

A depth D of the axially facing concave portion, along the longitudinal axis A, may be based on the size and strength of the corresponding sealing member (e.g., as shown in FIG. 4 at numeral 66). For example, the depth D may be anywhere from 10% to 25% of the radius of the axially facing concave portion 64 relative to the circular axis B.

Turning now to FIG. 14, a seal retainer is shown at 60b. The seal retainer 60b is substantially the same as the above-referenced seal retainers 60, 60a, and consequently the same reference numerals denote structures corresponding to similar structures in the seal retainers. In addition, the foregoing description of the seal retainers 60, 60a is equally applicable to the following seal retainer 60b except as noted below. Moreover, it will be appreciated that aspects of the seal retainers may be substituted for one another or used in conjunction with one another where applicable.

The seal retainer 60b may include an axially facing retainer surface 62 with an axially facing concave portion 64. The axially facing concave portion 64 may have a trapezoidal-shape cross-section for receiving a closed end of a sealing member, for example a C-shape sealing member opening axially as shown in FIGS. 4-8, 11, and 12. The axially facing concave portion 64 may face a direction parallel to a longitudinal axis A and extend along a circular axis B.

An angle θᵢ may be formed by a radially inner radially outwardly facing surface 260, extending coaxially with the longitudinal axis A, and an axially facing surface 262 of the axially facing concave portion 64. The axially facing surface 262 may extend coaxially with the longitudinal axis A. The angle θᵢ may be based on the size and strength of the sealing member (e.g., as shown in FIG. 4 at numeral 66). For example, the angle θᵢ may be 120°. In an embodiment, the angle θᵢ is anywhere from 120° to 150°. In another embodiment the axially facing surface is angled at least partially radially outwardly or radially inwardly, relative to the longitudinal axis.

An angle θₒ may be formed by a radially outer radially inwardly facing surface 264, extending coaxially with the longitudinal axis A, and the axially facing surface 262 of the axially facing concave portion 64. The angle θₒ may be based on the size and strength of the sealing member (e.g., as shown in FIG. 4 at numeral 66). For example, the angle θₒ may be 120°. In an embodiment, the angle θₒ is anywhere from 120° to 150°.

A depth D of the axially facing concave portion, along the longitudinal axis A, may based on the function and radius of the sealing member 66. For example, the depth may be anywhere from 10% to 25% the radius of the sealing member.

A minor width W of axially facing concave portion 64 relative to the circular axis B may be less than the radius of the sealing member 66. A major width of the axially facing concave portion 64 is greater than the radius of the sealing member to allow the sealing member 66. The major width being great than the radius of the sealing member 64 allows outer ends of the sealing member 66 to expand when pressurized.

A first aspect of the invention is a seal retainer of a hydraulic component. In an exemplary embodiment, the seal retainer includes a radially inward facing surface extending about a longitudinal axis and extending along the longitudinal axis, an axially facing surface extending radially outward from the radially inward facing surface, the axially facing surface facing in a first direction along the longitudinal axis, and an axially facing concave portion formed in the axially facing surface, the axially facing concave portion facing in the first direction and configured to receive a convex face of a sealing member, wherein the axially facing concave portion extends along a curved axis, the curved axis being coaxial with the longitudinal axis and circumscribing the longitudinal axis.

In an exemplary embodiment, the seal retainer may further include the sealing member, wherein the convex face is seated in the axially facing concave portion.

In an exemplary embodiment, the sealing member may include a C-ring seal that is open in the first direction, wherein the C-ring seal may include the convex face and the convex face faces in a second direction opposite the first direction for the convex face to engage the axially facing concave portion.

In an exemplary embodiment, the axially facing concave portion may form a symmetrical concavity about the longitudinal axis, wherein the symmetrical concavity is configured to concentrically receive the sealing member.

In an exemplary embodiment, the axially facing concave portion may have a radius relative to the curved axis.

In an exemplary embodiment, the radius of the axially facing concave portion may be greater than a radius, relative to the curved axis of the convex face of the sealing member, thereby allowing the sealing member to expand within the axially facing concave portion.

In an exemplary embodiment, the axially facing concave portion may have a C-shape cross-section facing the curved axis.

In an exemplary embodiment, the axially facing concave portion may have a V-shape cross-section facing the curved axis.

In an exemplary embodiment, the axially facing concave portion may have a trapezoidal-shape cross-section facing the curved axis.

In an exemplary embodiment, the seal retainer may include a ring that is coaxial with the longitudinal axis.

In an exemplary embodiment, the curved axis may be a circular axis.

Another aspect of the invention is a hydraulic coupling. In an exemplary embodiment, the hydraulic coupling includes a female hydraulic coupling component and a male hydraulic coupling component engaged with the female hydraulic coupling component, wherein the female hydraulic coupling component that includes a housing having an opening configured to receive a male hydraulic coupling component, and having a flow cavity fluidly connectable to the opening and extending along a longitudinal axis, and a seal retainer in the opening, the seal retainer that includes a radially inward facing surface extending about the longitudinal axis and extending along the longitudinal axis, wherein the radially inward facing surface is configured to receive a radially outwardly facing surface of the male hydraulic coupling component, an axially facing surface extending radially outward from the radially inward facing surface, the axially facing surface facing in a first direction along the longitudinal axis, and an axially facing concave portion formed in the axially facing surface, the axially facing concave portion facing in the first direction and configured to receive a convex face of a sealing member, wherein the axially facing concave portion extends along a curved axis, the curved axis being coaxial with the longitudinal axis and circumscribing the longitudinal axis. The hydraulic coupling may include any of the above or following features either individually or in combination with one another.

In an exemplary embodiment, the hydraulic coupling may further include the sealing member having the convex face, wherein the convex face of the sealing member is seated in the axially facing concave portion.

In an exemplary embodiment, the sealing member may be configured to receive flow from the flow cavity, and wherein the sealing member expands upon receiving flow from the flow cavity.

In an exemplary embodiment, the sealing member may include a C-ring seal that is open in the first direction, wherein the C-ring seal may include the convex face and the convex face faces in a second direction opposite the first direction for the convex face to engage the axially facing concave portion.

In an exemplary embodiment, the axially facing concave portion may form a symmetrical concavity about the longitudinal axis, wherein the symmetrical concavity may be configured to concentrically receive the sealing member.

In an exemplary embodiment, the axially facing concave portion may have a radius relative to the curved axis.

In an exemplary embodiment, the radius of the axially facing concave portion may be greater than a radius, relative to the curved axis, of the convex face of the sealing member, thereby allowing the sealing member to expand within the axially facing concave portion.

In an exemplary embodiment, the axially facing concave portion may have a C-shape cross-section facing the curved axis.

In an exemplary embodiment, the axially facing concave portion may have a V-shape cross-section facing the curved axis.

In an exemplary embodiment, the axially facing concave portion may have a trapezoidal-shape cross-section facing the curved axis.

In an exemplary embodiment, the seal retainer may include a ring that is coaxial with the longitudinal axis.

In an exemplary embodiment, the curved axis may be a circular axis.

In an exemplary embodiment, the housing may further include a seat surrounding a portion of the flow cavity, and the hydraulic coupling may further include a valve member moveable within the flow cavity, the valve member being moveable between a closed position and an open position, when in the closed position the valve member is engaged with the valve seat to prevent flow through the flow cavity, and when in the open position the valve member is spaced from the valve seat to allow fluid to flow through the flow cavity.

In an exemplary embodiment, the sealing member may be configured to receive flow from the flow cavity when the valve is opened by the male hydraulic coupling component.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. An assembly for a hydraulic component, the assembly comprising:
a seal retainer comprising:
a radially inward facing surface extending about a longitudinal axis and extending along the longitudinal axis;
an axially facing surface extending radially outward from the radially inward facing surface, the axially facing surface facing in a first direction along the longitudinal axis; and
an axially facing concave portion formed in the axially facing surface, the axially facing concave portion facing in the first direction and configured to receive a convex face of a sealing member, wherein the axially facing concave portion extends along a curved axis, the curved axis being coaxial with the longitudinal axis and circumscribing the longitudinal axis;
the assembly further comprising:
the sealing member, wherein the convex face is seated in the axially facing concave portion, and wherein the convex face forms an axial end of the sealing member;
wherein when the sealing member is pressurized,
the sealing member is engaged with the axially facing surface of the seal retainer to prevent the sealing member from moving in a second direction opposite to the first direction;
radially outer and radially inner portions of the sealing member expand radially, relative to the longitudinal axis; and
the axially facing surface of the seal retainer partially limits the expansion to reduce stress of the sealing member and the axially facing surface of the seal retainer reinforces a curvature of the sealing member, thereby preventing flattening of the sealing member to improve sealing effectiveness of the sealing member;
wherein the convex face faces opposite the axially facing concave portion to allow the convex face and the axially facing concave portion to engage one another; and
wherein the convex face circumscribes the curved axis B with a radius less than a corresponding radius of the axially facing concave portion to allow the convex face to expand radially outward from the circular axis after abutting a portion of the axially facing surface that defines the axially facing concave portion.

2. (canceled)

3. The assembly of claim 1, wherein the sealing member includes a C-ring seal that is open in the first direction, wherein the C-ring seal includes the convex face.

4. The assembly of claim 1, wherein the axially facing concave portion forms a symmetrical concavity about the longitudinal axis, wherein the symmetrical concavity is configured to concentrically receive the sealing member.

5-6. (canceled)

7. The assembly of claim 1, wherein the axially facing concave portion has a C-shape cross-section facing the curved axis.

8. The assembly of claim 1, wherein the axially facing concave portion has a V-shape cross-section facing the curved axis.

9. The assembly of claim 1, wherein the axially facing concave portion has a trapezoidal-shape cross-section facing the curved axis.

10. The assembly of claim 1, wherein the seal retainer includes a ring that is coaxial with the longitudinal axis.

11. (canceled)

12. A hydraulic coupling comprising:
a female hydraulic coupling component and a male hydraulic coupling component engaged with the female hydraulic coupling component, wherein the female hydraulic coupling component comprises:
a housing having an opening configured to receive the male hydraulic coupling component, and having a flow cavity fluidly connectable to the opening and extending along a longitudinal axis, wherein the housing further comprises a seat surrounding a portion of the flow cavity; and
a seal retainer in the opening, the seal retainer comprising:
a radially inward facing surface extending about the longitudinal axis and extending along the longitudinal axis, wherein the radially inward facing surface is configured to receive a radially outwardly facing surface of the male hydraulic coupling component;
an axially facing surface extending radially outward from the radially inward facing surface, the axially facing surface facing in a first direction along the longitudinal axis; and
an axially facing concave portion formed in the axially facing surface, the axially facing concave portion facing in the first direction and configured to receive a convex face of a sealing member, wherein the axially facing concave portion extends along a curved axis, the curved axis being coaxial with the longitudinal axis and circumscribing the longitudinal axis;
the female hydraulic coupling component further comprising:
the sealing member, wherein the convex face is seated in the axially facing concave portion, and wherein the convex face forms an axial end of the sealing member;
wherein when the sealing member is pressurized,
the sealing member is engaged with the axially facing surface of the seal retainer to prevent the sealing member from moving in a second direction opposite to the first direction;
radially outer and radially inner portions of the sealing member expand radially, relative to the longitudinal axis; and
the axially facing surface of the seal retainer partially limits the expansion to reduce stress of the sealing member and the axially facing surface of the seal retainer reinforces a curvature of the sealing member, thereby preventing flattening of the sealing member to improve sealing effectiveness of the sealing member;
the hydraulic coupling further comprising:
a valve member moveable within the flow cavity, the valve member being moveable between a closed position and an open position, when in the closed position the valve member is engaged with the valve seat to prevent flow through the flow cavity, and when in the open position the valve member is spaced from the valve seat to allow fluid to flow through the flow cavity.

13. (canceled)

14. The hydraulic coupling of claim 12, wherein the sealing member is configured to receive flow from the flow cavity, and wherein the sealing member expands upon receiving flow from the flow cavity.

15. The hydraulic coupling of claim 12, wherein the sealing member includes a C-ring seal that is open in the first direction, wherein the C-ring seal includes the convex face and the convex face faces in the second direction for the convex face to engage the axially facing concave portion.

16. The hydraulic coupling of claim 12, wherein the axially facing concave portion forms a symmetrical concavity about the longitudinal axis, wherein the symmetrical concavity is configured to concentrically receive the sealing member.

17. The hydraulic coupling of claim 12, wherein the axially facing concave portion has a radius relative to the curved axis.

18. The hydraulic coupling of claim 17, wherein the radius of the axially facing concave portion is greater than a radius, relative to the curved axis, of the convex face of the sealing member, thereby allowing the sealing member to expand within the axially facing concave portion.

19. The hydraulic coupling of claim 12, wherein the axially facing concave portion has a C-shape cross-section facing the curved axis.

20-24. (canceled)

25. The hydraulic coupling of claim 12, wherein the sealing member is configured to receive flow from the flow cavity when the valve member is opened by the male hydraulic coupling component.

26. The assembly or hydraulic coupling of claim 1, wherein a depth D of the axially facing concave portion, along the longitudinal axis, is between 10% and 25% of a radius of the axially facing concave portion relative to the curved axis B.

27-28. (canceled)

29. The assembly or hydraulic coupling of claim 1, wherein a radius of the axially facing concave portion may be between about 3% and about 10% larger than a radius of the sealing member relative to the curved axis to allow the sealing member to expand radially outward relative to the curved axis.

30. (canceled)

31. The assembly or hydraulic coupling of claim 1, wherein the entire axially facing concave portion is radially between a radially inner portion of the sealing member and a radially outer portion of the sealing member, relative to the longitudinal axis.

32. The assembly or hydraulic coupling of claim 1, wherein the sealing member is metal.

33. The hydraulic coupling of claim 12, wherein when the sealing member is pressurized the radially outer portion of the sealing member seals against a portion of a radially inward facing surface of the housing, and the radially inner portion of the sealing member seals against a portion of a radially outward facing surface of the male hydraulic coupling component; and
wherein the axially facing concave portion is entirely axially offset along the longitudinal axis from the portion of the radially inward facing surface of the housing and the portion of the radially outward facing surface of the male hydraulic coupling component.
